(19) United States
(12) Patent Application Publication
(10) Pub. No.: US 2024/0271001 A1
(43) Pub. Date: Aug. 15, 2024

(54) ANTI-GLARE FILM

(71) Applicant: BenQ Materials Corporation, Taoyuan City (TW)

(72) Inventors: Tsun-Sheng TAO, Taoyuan City (TW); Kuo-Hsuan YU, Taoyuan City (TW)

(21) Appl. No.: 18/336,943

(22) Filed: Jun. 16, 2023

(30) Foreign Application Priority Data
Feb. 9, 2023 (TW) 112104511

(51) Int. Cl. C09D 175/06; C08K 7/18

(52) U.S. Cl. CPC C09D 175/06; C08K 7/18; C08K 2201/005; C08K 2201/006

(57) ABSTRACT

The present invention is to provide an anti-glare film. The anti-glare film comprises a transparent substrate and an anti-glare layer formed on a surface of the transparent substrate, wherein the anti-glare layer comprises an acrylate binder resin and a plurality of silica microparticles, wherein the particle size of the silica microparticles is ranging between 2 μm and 6 μm and the BET specific surface area is not more than 250 m²/g, and the amount of the silica microparticles is ranging between 3 to 20 parts by weight per hundred parts by weight of the acrylate binder resin. The anti-glare film provides an enhanced abrasion-resistance.

### CROSS-REFERENCE TO RELATED APPLICATION

This application claims the priority benefit of Taiwanese Application Serial Number 112104511, filed Feb. 9, 2023, which is incorporated herein by reference.

### BACKGROUND

### Field of Invention

The present invention relates to an anti-glare film, and more particularly to an anti-glare film with enhanced abrasion-resistance.

### Description of Related Art

To improve the quality of display, the functional optical film such as anti-glare films or anti-reflection films are widely applied on the surface of the image display devices such as liquid crystal displays (LCD) or organic light-emitting diode displays (OLED).

In the state of related art, the anti-glare film can provide anti-glare properties by coating microparticles on the surface thereof to form a concave-convex structure for scattering the external incident light at the viewing side. However, the concave-convex structure on the surface is easily to be damaged through scratching or rubbing away in the application environment to cause the anti-glare properties declined, especially when the anti-glare film is applied to a touch screen display. With the increasing demand of the touchscreen display, there is a need of an anti-glare film with enhanced abrasion-resistance.

### SUMMARY

The present invention is to provide an anti-glare film comprising a transparent substrate and an anti-glare layer formed on a surface of the transparent substrate. The anti-glare layer comprises an acrylate binder resin and a plurality of spherical silica microparticles, wherein the particle size of the spherical silica microparticles is ranging between 2 μm and 6 μm and the specific surface area measured by BET(Brunauer-Emmett-Teller) method thereof is not more than 250 m²/g, and the amount of the spherical silica microparticles is in the range from 3 to 20 parts by weight per hundred parts by weight of acrylate binder resin.

In the anti-glare film of the present invention, the compressive strength of the spherical silica microparticles used in the anti-glare layer is not less than 25 GPa.

In the anti-glare film of the present invention, the span ((D90-D10)/D50) of the spherical silica microparticles used in the anti-glare layer is not more than 1.1.

The total haze of the present anti-glare film is ranging between 8% and 40% and preferably ranging between 10% and 35%.

The initial haze (H₁%) of the anti-glare film was measured according to the test method of JIS K7136, then the anti-glare film was rubbed by reciprocating abraser (Model 5900, available from Taber Industries, USA) with Taber Wearaser® CS-7 calibrase with a load of 150 gf at a speed of 60 rpm for 10,000 times. The haze (H₂%) of the after-abraded anti-glare film was measured according to the test method of JIS K7136. The haze difference (ΔH) of the initial haze (H₁%) and the haze (H₂%) is less than 3%.

The present anti-glare film further comprises a plurality of organic microparticles, the particle size of the organic microparticles is ranging between 1 μm and 7 μm and preferably ranging between 2 μm and 6 μm, and the amount of the organic microparticles is 3 parts and 11 parts by weight per hundred parts by weight of acrylate binder resin.

The total haze of the anti-glare film comprising organic microparticles of the present invention is ranging between 20% and 60%. In the anti-glare film of the present invention, the acrylate binder resin of the anti-glare layer comprises a (meth)acrylate composition and an initiator, wherein the (meth)acrylate composition comprises 35 parts to 50 parts by weight of polyurethane (meth)acrylate oligomer with a functionality of 6 to 15 and a molecular weight of 1,000 to 4,500, 12 parts to 20 parts by weight of a (meth)acrylate monomer with a functionality of 3 to 6 and 1.5 parts to 12 parts by weight of a (meth)acrylate monomer with a functionality less than 3.

The above and other aspects of the invention will become better understood with regard to the following detailed description of the preferred but non-limiting embodiment(s). These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

These and other features, aspects, and advantages of the present invention will become better understood with reference to the following description and appended claims.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

It is apparent that departures from specific designs and methods described and shown will suggest themselves to those skilled in the art and may be used without departing from the spirit and scope of the invention. The present invention is not restricted to the particular constructions described and illustrated, but should be construed to cohere with all modifications that may fall within the scope of the appended claims.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The term “(meth)acrylate” used herein refers to acrylate or methacrylate.

The present invention is to provide an anti-glare film with enhanced abrasion-resistance, comprising a transparent substrate and an anti-glare layer formed on a surface of the transparent substrate. The anti-glare layer comprises an acrylate binder resin and a plurality of spherical silica microparticles, wherein the particle size of the spherical silica microparticles is ranging between 2 μm and 6 μm and the BET specific surface area is not more than 250 m²/g, and the amount of the spherical silica microparticles is in the range from 3 to 20 parts by weight per hundred parts by weight of acrylate binder resin.

In an embodiment of the present invention, the thickness of the anti-glare layer of the anti-glare film is ranging from 2 μm to 10 μm and preferably ranging from 3 μm to 9 μm.

The total haze of the present anti-glare film is ranging between 8% and 40% and preferably ranging between 10% and 35%.

In the anti-glare film of the present invention, the BET specific surface area of the spherical silica microparticles used in the anti-glare layer is preferably not more than 200 m²/g and more preferably not more than 100 m²/g.

In an embodiment of the present anti-glare film, the compressive strength of the spherical silica microparticles used in the anti-glare layer is not less than 25 GPa and preferably not less than 30 GPa. The term “compressive strength” used herein refers to the average of 10% compressive strength (K10 Value) of the spherical silica microparticles, measured by MCT-510 Strength Evaluation Tester (available from Shimadzu Scientific Instrument, Japan) with a load of 20 mN and a speed of 2.231 mN/sec for 5 repeated times.

In an embodiment of the present anti-glare film, the spherical silica microparticles used in the anti-glare layer are particles with high consistent particle sizes to achieve a stable concave-convex structure on the surface of the anti-glare film, the span ((D90-D10)/D50) of the spherical silica microparticles used in the anti-glare layer is not more than 1.1 and preferably less than 0.9. The span measurement was measured by LA-300 Particle Size Analyzer (available from HORIBA Scientific, Japan), wherein the microparticles were dispersed completely in ethyl acetate, and D90 is the particle size value when the cumulative particle size distribution percentage reaches 90%; D50 is the particle size value when the cumulative particle size distribution percentage reaches 50%; D10 is the particle size when the cumulative particle size distribution percentage reaches 10%, and the span of the particles is calculated by the formula (D90-D10)/D50.

After the initial haze (H₁%) of the anti-glare film was measured according to the test method of JIS K7136, the anti-glare film was rubbed by reciprocating abraser (Model 5900, available from Taber Industries, USA) with Taber Wearaser® CS-7 calibrase with a load of 150 gf at a speed of 60 rpm for 10,000 times. The haze (H₂%) of the after-abraded anti-glare film was measured according to the test method of JIS K7136. The haze difference (ΔH) of the initial haze (H₁%) and the haze (H₂%) is less than 3% and preferably less than 2.5%.

The anti-glare film of the present invention can further comprise a plurality of organic microparticles to adjust the total haze of the anti-glare film. The organic microparticles suitable for the present anti-glare film can be selected from those commonly used in the related art, the particle size of the organic microparticles is ranging between 1 μm and 7 μm and the amount of the organic microparticles is ranging between 3 parts and 11 parts by weight and preferably is ranging between 5 parts and 10 parts by weight per hundred parts by weight of acrylate binder resin. The haze of present anti-glare film can be adjusted by adding organic microparticles without reducing the abrasion-resistance properties thereof.

The organic microparticles suitable for the present anti-glare film can be hydrophilic-modified or unmodified organic micoparticles of polymethyl methacrylate resin, polystyrene resin, styrene-methyl methacrylate copolymer, polyethylene resin, epoxy resin, silicone resin, melamine resin, polyvinylidene fluoride resin or polyvinyl fluoride resin. The particle size of the suitable organic microparticles is ranging between 1 μm and 7 μm and preferably ranging between 2 μm and 6 μm. In a preferred embodiment of the present anti-glare film, the organic microparticles can be polymethyl methacrylate resin microparticles, polystyrene resin microparticles or styrene-methyl methacrylate copolymer microparticles. The total haze of the anti-glare film comprising organic microparticles of the present invention is ranging between 20% and 60%.

In an embodiment of the present anti-glare film, the suitable transparent substrate can be the film with a good mechanical strength and light transmittance. The examples of the substrate can be but not limited to polymethyl methacrylate (PMMA), polyethylene terephthalate (PET), polyethylene naphthalate (PEN), polycarbonate (PC), triacetate cellulose (TAC), polyimide (PI), polyethylene (PE), polypropylene (PP), polyvinyl alcohol (PVA), polyvinyl chloride (PVC) or cyclic olefin copolymer (COC) and the like.

In an embodiment of the anti-glare film of the present invention, the light transmittance of the transparent substrate is more than 80% and preferably more than 90%. The thickness of the transparent substrate is ranging between 10 μm and 500 μm, preferably ranging between 15 μm and 250 μm, and more preferably ranging between 20 μm and 100 μm.

In a preferred embodiment of the anti-glare layer of the present anti-glare film, the acrylate binder resin comprises a (meth)acrylate composition and an initiator, wherein the (meth)acrylate composition comprises 35 parts to 50 parts by weight of polyurethane (meth)acrylate oligomer with a functionality of 6 to 15 and a molecular weight of 1,000 to 4,500, 12 parts to 20 parts by weight of a (meth)acrylate monomer with a functionality of 3 to 6 and 1.5 parts to 12 parts by weight of (meth)acrylate monomer with a functionality less than 3.

In a preferred embodiment of the anti-glare layer of the present anti-glare film, the polyurethane (meth)acrylate oligomer with a functionality of 6 to 15 can be an aliphatic polyurethane (meth)acrylate oligomer with a functionality of 6 to 15.

In an embodiment of the anti-glare layer of the present anti-glare film, the molecular weight of the (meth)acrylate monomer with a functionality of 3 to 6 is less than 1,000 and preferably less than 800. The suitable (meth)acrylate monomer with a functionality of 3 to 6 can be pentaerythritol tetra(meth)acrylate, dipentaerythritol penta(meth)acrylate (DPP(M)A), dipentaerythritol hexa(meth)acrylate (DPH(M)A), trimethylolpropane tri(meth)acrylate (TMPT(M)A), ditrimethylolpropane tetra(meth)acrylate (DTMPT(M)A), pentaerythritol tri(meth)acrylate (PET(M)A) or combinations thereof; and preferably is pentaerythritol triacrylate (PETA), dipentaerythritol hexaacrylate (DPHA), dipentaerythritol pentaacrylate (DPPA), or combinations thereof.

In an embodiment of the anti-glare layer of the present anti-glare film, the (meth)acrylate monomer with a functionality less than 3 can be a (meth)acrylate monomer with a functionality of 1 or 2 and the molecular weight thereof is less than 500. The suitable (meth)acrylate monomer with a functionality less than 3 can be 2-ethylhexyl (meth)acrylate (2-EH(M)A), 2-hydroxyethyl (meth)acrylate (2-HE(M)A), 2-hydroxypropyl (meth)acrylate (2-HP(M)A), 2-hydroxybutyl (meth)acrylate (2-HB(M)A), 2-butoxyethyl (meth)acrylate, 1,6-hexanediol di(meth)acrylate (HDD(M)A), cyclic trimethylolpropane formal (meth)acrylate (CTF(M)A), 2-phenoxyethyl (meth)acrylate (PHE(M)A), tetrahydrofurfuryl (meth)acrylate (THF(M)A), lauryl (meth)acrylate (L(M)A), diethylene glycol di(meth)acrylate (DEGD(M)A), dipropylene glycol di(meth)acrylate (DPGD(M)A), tripropylene glycol di(meth)acrylate (TPGD(M)A), isobornyl (meth)acrylate (IBO(M)A), or combinations thereof; and preferably is 1,6-hexanediol diacrylate (HDDA), cyclic trimethylolpropane formal acrylate (CTFA), 2-phenoxyethyl acrylate (PHEA), or combinations thereof.

In the anti-glare layer of the present anti-glare film, the suitable initiator can be selected from those commonly used in the related art, such as, but not limited to acetophenones initiator, diphenylketones initiator, initiator, benzophenones initiator, difunctional α-hydroxyketones initiator and acyl phosphine oxides initiator, or combinations thereof.

The anti-glare layer of the present anti-glare film can be further added a leveling agent for enhancing the surface coverage and smoothness of the anti-glare layer and thus, the surface of the anti-glare layer obtained after drying can be a smooth one with antifouling and abrasion resistance. The leveling agents used in the anti-glare layer of the present anti-glare film can be fluorine-based, (meth)acrylate-based or organosilicon-based leveling agent.

The method for preparing the present anti-glare film comprises the steps of mixing a polyurethane (meth)acrylate oligomer with a functionality of 6 to 15 and a molecular weight of 1,500 to 4,500, a (meth)acrylate monomer with a functionality of 3 to 6, a (meth)acrylate monomer with a functionality less than 3 and an initiator evenly to form an acrylate binder resin; adding spherical silica microparticles with an particle size of 2 μm to 6 μm and a BET specific surface area of not more than 250 m²/g and a suitable solvent to the acrylate binder resin and mixing evenly to form an anti-glare coating solution; coating the anti-glare coating solution on a transparent substrate, drying to remove the solvent and curing via radiation or electron beam to form an anti-glare layer on the substrate to obtain an anti-glare film.

The solvents suitable for preparation of the present anti-glare film can be the organic solvents commonly used in the related art, such as ketones, aliphatic, cycloaliphatic or aromatic hydrocarbons, ethers, esters or alcohols. The acrylate binder resin or the anti-glare coating solution can use one or more organic solvents. The suitable organic solvent can be such as, acetone, butanone, cyclohexanone, methyl isobutyl ketone, hexane, cyclohexane, dichloromethane, dichloroethane, toluene, xylene, propylene glycol methyl ether, methyl acetate, ethyl acetate, propyl acetate, butyl acetate, n-butanol, isobutanol, isopropanol, diacetone alcohol, propylene glycol methyl ether acetate, cyclohexanol or tetrahydrofuran and the likes, but not limited thereto.

In other embodiments of the present invention, other additives such as antistatic agents, colorants, flame retardants, ultraviolet absorbers, antioxidants, antibacterial agents, surface modifiers, leveling agents or defoaming agents can be added to the aforementioned anti-glare coating solution as required. The above-mentioned anti-glare coating solution can be applied to the substrate surface by any method known in the related art, for example, bar coating, blade coating, dip coating, roll coating, spinning coating, slot-die coating and the like.

The present invention will be further described with reference to following Examples but the present invention is not limited to the description thereof.

### EXAMPLE

The particles used in the Examples of the present invention are as follows:
SUNSPHERE® NP-30: spherical silica microparticles, particle size 4 μm, BET specific surface area 40 m²/g, compressive strength 44.8 Gpa, the span of the particles 0.71, available from AGC Si-Tech Co., Ltd., Japan;
HIPRESICA N3N: spherical silica microparticles, particle size 4 μm, BET specific surface area 3 m²/g, compressive strength 32.4 Gpa, the span of the particles 0.42, available from UBE EXSYMO Co., Ltd., Japan;
Nipsil® SS-50B: amorphous silica microparticles, particle size 4 μm, BET specific surface area 80 m²/g, compressive strength 33.9 Gpa, the span of the particles 1.04, available from Tosoh Silica Corporation, Japan;
SUNSPHERE® L-31: spherical silica microparticles, particle size 3 μm, BET specific surface area 300 m²/g, compressive strength 4.4 Gpa, the span of the particles 0.69, available from AGC Si-Tech Co., Ltd., Japan;
XX-40IK: polystyrene microparticles, particle size 3 μm, available from Sekisui Kasei Co., Ltd., Japan;
SSX-104DXE: methyl methacrylate and styrene copolymer microparticles, particle size 4 μm, available from Sekisui Kasei Co., Ltd., Japan;
SSX-1055QXE: methyl methacrylate and styrene copolymer microparticles, particle size 5.5 μm, available from Sekisui Kasei Co., Ltd., Japan.

### Preparation Example 1: Preparation of Acrylate Binder Resin I

42 weight parts of polyurethane acrylate oligomer (functionality 6, molecular weight of about 2,600, viscosity of 62,000 cps (at 25° C.), commercially obtained from Miwon, Korea), 4.5 weight parts of PETA, 12 weight parts of DPHA, 3 weight parts of IBOA, 4 weight parts of photoinitiator (Chemcure-481, commercially obtained from Chembridge, Taiwan), 24.5 weight parts of ethyl acetate (EAC) and 10 weight parts of n-butyl acetate (n-BAC) were mixed and stirred for 1 hour to prepare the acrylate binder resin I.

### Preparation Example 2: Preparation of the Acrylate Binder Resin II

42 weight parts of polyurethane acrylate oligomer (functionality 9, molecular weight of about 2,000, viscosity of 86,000 cps (at 25° C.), commercially obtained from Allnex, USA), 4.5 weight parts of PETA, 10.5 weight parts of DPHA, 4.5 weight parts of 1,6-hexanediol diacrylate (HDDA), 1.5 weight parts of 2-phenoxy ethyl acrylate (PHEA), 3.5 weight parts of photoinitiator (Chemcure-481, commercially obtained from Chembridge, Taiwan), 0.5 weight parts of photoinitiator (TR-PPI-one, commercially obtained from Tronly Eterprise Co., Hong Kong), 24.5 weight parts of ethyl acetate (EAC) and 10 weight parts of n-butyl acetate (n-BAC) were mixed and stirred for 1 hour to prepare the acrylate binder resin II.

### Example 1: Preparation of Anti-Glare Film

200 weight parts of acrylate binder resin I, 23.1 weight parts of silica microparticles (SUNSPHERE® NP-30), 5 weight parts of polyether-modified polydimethylsiloxane leveling agent (BYK-333, solid content 10%, solvent: ethyl acetate, available from BYK, Germany), 85 weight parts of ethyl acetate and 126 weight parts of n-butyl acetate (n-BAC) were mixed for 1 hour to form an anti-glare coating solution. The prepared anti-glare coating solution was coated on a 80 μm triacetyl cellulose (TAC) film. After the coating layer was dried, the layer was cured by exposure to UV light in a cumulative dosage of 298 mJ/cm² under nitrogen atmosphere. Thus, an anti-glare film comprising an anti-glare layer with a thickness of 7.6 μm formed on the substrate was obtained.

The optical and physical properties of the obtained anti-glare film were determined in accordance with the measurement described hereinafter. The test results were shown in Table 3.

### Example 2: Preparation of Anti-Glare Film

200 weight parts of acrylate binder resin II, 10 weight parts of silica microparticles (HIPRESICA N3N), 5 weight parts of polyether-modified polydimethylsiloxane leveling agent (BYK-307, solid content 10%, solvent: ethyl acetate, available from BYK, Germany), 785 weight parts of ethyl acetate and 160 weight parts of n-butyl acetate were mixed for 1 hour to form an anti-glare coating solution. The prepared anti-glare coating solution was coated on a 80 μm triacetyl cellulose (TAC) film. After the coating layer was dried, the layer was cured by exposure to UV light in a cumulative dosage of 298 mJ/cm² under nitrogen atmosphere. Thus, an anti-glare film comprising an anti-glare layer with a thickness of 5.2 μm formed on the substrate was obtained.

The optical and physical properties of the obtained anti-glare film were determined in accordance with the measurement described hereinafter. The test results were shown in Table 3.

### Examples 3 and 4: Preparation of Anti-Glare Film

The anti-glare films of Examples 3 and 4 were prepared in the same manner as in Example 1, except that the amount of the silica microparticles and the ethyl acetate used and the thickness of the obtained anti-glare films comprising anti-glare layers were different as shown in Table 1. The optical and physical properties of the obtained anti-glare films were determined in accordance with the measurement described hereinafter. The test results were shown in Table 3.

TABLE 1
The amount of the silica microparticles and
the ethyl acetate used in Examples 3 and 4

| | | | Thickness of the |
|---|---|---|---|
| | HIPRESICA N3N | Ethyl acetate | anti-glare layer |
| Examples | (weight parts) | (weight parts) | (μm) |
| Example 3 | 7.2 | 178 | 5.2 |
| Example 4 | 4.4 | 170 | 4.8 |

### Example 5: Preparation of Anti-Glare Film

200 weight parts of acrylate binder resin II, 11.6 weight parts of silica microparticles (HIPRESICA N3N), 11.6 weight parts of polystyrene microparticles (XX-40IK), 5 weight parts of polyether-modified polydimethylsiloxane leveling agent (BYK-307), 130 weight parts of ethyl acetate (EAC) and 80 weight parts of n-butyl acetate (nBAC) were mixed for 1 hour to form an anti-glare coating solution. The prepared anti-glare coating solution was coated on a 80 μm triacetyl cellulose (TAC) film. After the coating layer was dried, the layer was cured by exposure to UV light in a cumulative dosage of 298 mJ/cm² under nitrogen atmosphere. Thus, an anti-glare film comprising an anti-glare layer with a thickness of 6.4 μm formed on the substrate was obtained.

The optical and physical properties of the obtained anti-glare film were determined in accordance with the measurement described hereinafter. The test results were shown in Table 3.

### Examples 6 to 10: Preparation of Anti-Glare Film

The anti-glare films of Examples 6 to 10 were prepared in the same manner as in Example 5, except that different organic particles and the amount thereof were added as shown in Table 2 and the thickness of the anti-glare layers of the anti-glare film were different. The optical and physical properties of the obtained anti-glare film were determined in accordance with the measurement described hereinafter. The test results were shown in Table 3.

TABLE 2
The organic particles and the amount
thereof used in Examples 6 to 10

| | | Amount of the | Thickness of the |
|---|---|---|---|
| | | organic particles | anti-glare layer |
| Examples | Organic particles | (weight parts) | (μm) |
| Example 6 | SSX-104DXE | 11.6 | 7.2 |
| Example 7 | SSX-1055QXE | 11.6 | 7.4 |
| Example 8 | XX-40IK | 8.0 | 5.8 |
| Example 9 | SSX-104DXE | 8.0 | 6.2 |
| Example 10 | SSX-1055QXE | 8.0 | 7.0 |

### Comparative Example 1: Preparation of Anti-Glare Film

200 weight parts of acrylate binder resin II, 2.8 weight parts of silica microparticles (HIPRESICA N3N), 5 weight parts of polyether-modified polydimethylsiloxane leveling agent (BYK-307), 169 weight parts of ethyl acetate (EAC) and 156 weight parts of n-butyl acetate (nBAC) were mixed for 1 hour to form an anti-glare coating solution. The prepared anti-glare coating solution was coated on a 80 μm triacetyl cellulose (TAC) film. After the coating layer was dried, the layer was cured by exposure to UV light in a cumulative dosage of 298 mJ/cm² under nitrogen atmosphere. Thus, an anti-glare film comprising an anti-glare layer with a thickness of 4.8 μm formed on the substrate was obtained.

The optical and physical properties of the obtained anti-glare film were determined in accordance with the measurement described hereinafter. The test results were shown in Table 3.

### Comparative Example 2: Preparation of Anti-Glare Film

200 weight parts of acrylate binder resin I, 23.1 weight parts of amorphous silica microparticles (Nipsil® SS-50B), 5 weight parts of polyether-modified polydimethylsiloxane leveling agent (BYK-333), 30 weight parts of ethyl acetate and 126 weight parts of n-butyl acetate were mixed for 1 hour to form an anti-glare coating solution. The prepared anti-glare coating solution was coated on a 80 μm triacetyl cellulose (TAC) film. After the coating layer was dried, the layer was cured by exposure to UV light in a cumulative dosage of 298 mJ/cm² under nitrogen atmosphere. Thus, an anti-glare film comprising an anti-glare layer with a thickness of 8.0 μm formed on the substrate was obtained.

The optical and physical properties of the obtained anti-glare film were determined in accordance with the measurement described hereinafter. The test results were shown in Table 3.

### Comparative Example 3: Preparation of Anti-Glare Film

200 weight parts of acrylate binder resin I, 23.1 weight parts of silica microparticles (SUNSPHERE® L-31), 5 weight parts of polyether-modified polydimethylsiloxane leveling agent (BYK-333), 30 weight parts of ethyl acetate and 126 weight parts of n-butyl acetate were mixed for 1 hour to form an anti-glare coating solution. The prepared anti-glare coating solution was coated on a 80 μm triacetyl cellulose (TAC) film. After the coating layer was dried, the layer was cured by exposure to UV light in a cumulative dosage of 298 mJ/cm² under nitrogen atmosphere. Thus, an anti-glare film comprising an anti-glare layer with a thickness of 8.2 μm formed on the substrate was obtained.

The optical and physical properties of the obtained anti-glare film were determined in accordance with the measurement described hereinafter. The test results were shown in Table 3.

Total haze measurement: The total haze was measured according to the test method of JIS K7136 by NDH-2000 Haze Meter (manufactured by Nippon Denshoku Industries, Japan).

Internal haze and surface haze measurement: The anti-glare films was adhered to a triacetyl cellulose substrate with transparent optical adhesive (T40UZ, thickness 40 μm, available from Fujifilm, Japan) to flatten the uneven surface of the anti-glare film. In this state, the haze of prepared sample measured according to the test method of JIS K7136 by NDH-2000 Haze Meter was the internal haze, and the surface haze could be obtained from the total haze deducted the internal haze.

Light transmittance measurement: The light transmittance was measured according to the test method of JIS K7361 by NDH-2000 Haze Meter (manufactured by Nippon Denshoku Industries, Japan).

Gloss measurement: The gloss of the obtained anti-glare films was measured by adhering the anti-glare films to a black acrylic plate and measuring the gloss thereof according to the test method of JIS Z8741 by BYK Micro-Gloss gloss meter at viewing angles of 20 and 60 degrees.

Pencil hardness test: The pencil hardness was measured according to the test method of JIS K5400. By a pencil scratch hardness tester (Model 553-M, manufactured by Yasuda Seiki Seisakusho, Japan), a Mitsubishi hardness pencil under a load of 500 g at a movement speed of 1 mm/sec to perform 5 times of pencil hardness test on the anti-glare film. In case that two or more visible scratches were observed on the surface of the test sample, the hardness was deemed as failure. The maximum hardness of the pencil used which made less than 2 scratches on the surface of film was recorded as the hardness of the anti-glare film.

Abrasion-resistance test and the haze difference after the abrasion-resistance test: The obtained anti-glare films were rubbed by reciprocating abraser (Model 5900, available from Taber Industries, USA) with Taber Wearaser® CS-7 calibrase, with a load of 150 gf and a speed of 60 rpm for 10,000 times, and evaluated the status of the surface of the anti-glare. If there was no scratch on the surface, the test sample was marked as “excellent” (o); there was scratch on the surface, the test sample was marked as “poor” (x). Furthermore, the after-abraded haze the anti-glare film was measured according to the method aforementioned, and the difference between the initial haze and the after-abraded haze of the anti-glare film was the haze difference (ΔH).

Anti-glare evaluation: The anti-glare films were adhered to a black acrylic plate, and the surfaces of the prepared samples were illuminated by 2 fluorescent tubes to check the status of reflected by visual observation. The evaluation criteria were as below.
Lv.1: Two separate fluorescent tubes could be seen clearly and the straight outlines of tubes were distinguished obviously;
Lv.2: Two separate fluorescent tubes could be seen clearly, but the outlines of tubes were slightly fuzzy;
Lv.3: Two separate fluorescent tubes could be seen, and although the outlines of tubes were slightly fuzzy but the shapes of tubes could be distinguished;
Lv.4: It could be seen that there are 2 fluorescent tubes, but the shapes of tubes could not be distinguished;
Lv.5: It could not be seen that there are 2 fluorescent tubes and the shapes of tubes could not be distinguished.

TABLE 3
The optical and physical properties test results of the anti-glare
films obtained from Examples 1 to 10 and Comparative Example 1 to 3

| | | | | | | | | | Abrasion-resistance | |
|---|---|---|---|---|---|---|---|---|---|---|
| Example/ | Total | Internal | Surface | Light | | | | | | Haze |
| Comparative | haze | haze | haze | transmittance | Gloss | | Anti-glare | | | difference |
| Example | (H₁ %) | (%) | (%) | (%) | 20° | 60° | property | Hardness | Evaluation | ΔH(%) |
| Example 1 | 27.0 | 18.2 | 8.8 | 90.7 | 4.1 | 25.1 | Lv.5 | 2H | ∘ | 0.24 |
| Example 2 | 29.6 | 7.7 | 21.9 | 89.9 | 3.2 | 21.2 | Lv.5 | 2H | ∘ | 0.63 |
| Example 3 | 19.1 | 5.6 | 13.6 | 89.9 | 5.1 | 30.3 | Lv.5 | 2H | ∘ | 1.57 |
| Example 4 | 13.7 | 3.6 | 10.1 | 89.9 | 7.8 | 38.4 | Lv.5 | 2H | ∘ | 1.18 |
| Example 5 | 47.3 | 35.0 | 12.3 | 91.6 | 4.7 | 28.3 | Lv.5 | 2H | ∘ | 0.28 |
| Example 6 | 27.4 | 15.6 | 11.8 | 91.2 | 7.5 | 28.7 | Lv.4 | 2H | ∘ | 0.12 |
| Example 7 | 41.5 | 16.2 | 25.3 | 90.8 | 2.6 | 16.0 | Lv.5 | 2H | ∘ | 2.23 |
| Example 8 | 40.8 | 27.5 | 13.3 | 90.9 | 2.5 | 18.3 | Lv.5 | 2H | ∘ | 0.04 |
| Example 9 | 41.3 | 15.7 | 25.6 | 90.5 | 1.4 | 12.2 | Lv.5 | 2H | ∘ | 1.14 |
| Example 10 | 40.7 | 17.9 | 22.8 | 90.9 | 1.9 | 14.2 | Lv.5 | 2H | ∘ | 2.19 |
| Comparative | 7.9 | 2.7 | 5.2 | 90.4 | 14.4 | 51.3 | Lv.4 | 2H | ∘ | 3.80 |
| Example 1 | | | | | | | | | | |
| Comparative | 71.4 | 2.7 | 68.8 | 92.4 | 0.3 | 3.9 | Lv.5 | 2H | x | 1.07 |
| Example 2 | | | | | | | | | | |
| Comparative | 61.4 | 12.1 | 49.3 | 91.6 | 0.5 | 6.3 | Lv.5 | 2H | ∘ | 5.90 |
| Example 3 | | | | | | | | | | |

As shown in Table 3, the anti-glare films obtained from Examples 1 to 10 provide an enhanced abrasion-resistance, there is no scratch on the film surface after the abrasion-resistance test and the haze difference (ΔH) of the anti-glare films are less than 2.23. The anti-glare films obtained in Examples 5 to 10, the anti-glare layer thereof further comprising organic microparticles, show higher haze. In Comparative Examples 1, the amount of the silica microparticles was less than 3 parts by weight per hundred parts by weight of acrylate binder resin in the anti-glare film obtained from; in Comparative Examples 2, the silica microparticles used in the anti-glare film were amorphous and had a span of 1.04; and in Comparative Examples 3, the silica microparticles used in the anti-glare film were microparticles having a BET specific surface area more than 250 m²/g. The anti-glare films obtained from Comparative Examples show an insufficient abrasion-resistance.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. An anti-glare film comprising a transparent substrate and an anti-glare layer formed on a surface of the transparent substrate, wherein the anti-glare layer comprising:
an acrylate binder resin; and
a plurality of spherical silica microparticles, wherein the particle size of the spherical silica microparticles is ranging between 2 μm and 6 μm, and the BET specific surface area is not more than 250 m²/g;
wherein the amount of the spherical silica microparticles is in the range from 3 to 20 parts by weight per hundred parts by weight of acrylate binder resin.

2. The anti-glare film as claimed in claim 1, wherein the compressive strength of the spherical silica microparticles used in the anti-glare layer is not less than 25 GPa.

3. The anti-glare film as claimed in claim 1, wherein the span ((D90-D10)/D50) of the spherical silica microparticles used in the anti-glare layer is not more than 1.1.

4. The anti-glare film as claimed in claim 1, wherein the total haze of the anti-glare film is ranging between 8% and 40%.

5. The anti-glare film as claimed in claim 4, wherein the total haze of the anti-glare film is ranging between 10% and 35%.

6. The anti-glare film as claimed in claim 1, wherein the initial haze (H₁%) of the anti-glare film is obtained by the test method of JIS K7136, then the anti-glare film is rubbed by reciprocating abraser (Model 5900, available from Taber Industries, USA) with Taber Wearaser® CS-7 calibrase with a load of 150 gf at a speed of 60 rpm for 10,000 times and the haze (H₂%) of the after-abraded anti-glare film is obtained by the test method of JIS K7136, and the haze difference (ΔH) of the initial haze (H₁%) and the after-abraded haze (H₂%) is less than 3%.

7. The anti-glare film as claimed in claim 1, wherein the anti-glare film further comprises a plurality of organic microparticles, the particle size of organic microparticles is ranging between 1 μm and 7 μm, and the amount of the organic microparticles is between 3 parts and 11 parts by weight per hundred parts by weight of acrylate binder resin.

8. The anti-glare film as claimed in claim 7, wherein the particle size of each one of the plurality of organic microparticles is ranging between 2 μm and 6 μm.

9. The anti-glare film as claimed in claim 7, wherein a total haze of the anti-glare film is ranging between 20% and 60%.

10. The anti-glare film as claimed in claim 1, wherein the acrylate binder resin of the anti-glare layer comprises a (meth)acrylate composition and an initiator, wherein the (meth)acrylate composition comprises 35 parts to 50 parts by weight of a polyurethane (meth)acrylate oligomer with a functionality of 6 to 15 and a molecular weight of 1,000 to 4,500, 12 parts to 20 parts by weight of a (meth)acrylate monomer with a functionality of 3 to 6 and 1.5 parts to 12 parts by weight of a (meth)acrylate monomer with a functionality less than 3.

11. The anti-glare film as claimed in claim 10, wherein the polyurethane (meth)acrylate oligomer with a functionality of 6 to 15 and a molecular weight of 1,000 to 4,500 is an aliphatic polyurethane (meth)acrylate oligomer.

12. The anti-glare film as claimed in claim 10, wherein the (meth)acrylate monomer with a functionality of 3 to 6 is selected from at least one of a group consisting of pentaerythritol tetra(meth)acrylate, dipentaerythritol penta(meth)acrylate (DPP(M)A), dipentaerythritol hexa(meth)acrylate (DPH(M)A), trimethylolpropane tri(meth)acrylate (TMPT(M)A), ditrimethylolpropane tetra(meth)acrylate (DTMPT(M)A), pentaerythritol tri(meth)acrylate (PET(M)A), and combinations thereof.

13. The anti-glare film as claimed in claim 10, wherein the (meth)acrylate monomer with a functionality less than 3 is selected from at least one of a group consisting of 2-ethylhexyl (meth)acrylate (2-EH(M)A), 2-hydroxyethyl (meth)acrylate (2-HE(M)A), 2-hydroxypropyl (meth)acrylate (2-HP(M)A), 2-hydroxybutyl (meth)acrylate (2-HB(M)A), 2-butoxyethyl (meth)acrylate, 1,6-hexanediol di(meth)acrylate (HDD(M)A), cyclic trimethylolpropane formal (meth)acrylate (CTF(M)A), 2-phenoxyethyl (meth)acrylate (PHE(M)A), tetrahydrofurfuryl (meth)acrylate (THF(M)A), lauryl (meth)acrylate (L(M)A), diethylene glycol di(meth)acrylate (DEGD(M)A), dipropylene glycol di(meth)acrylate (DPGD(M)A), tripropylene glycol di(meth)acrylate (TPGD(M)A), isobornyl (meth)acrylate (IBO(M)A), and combinations thereof.

14. The anti-glare film as claimed in claim 10, wherein the initiator is selected from at least one of a group consisting of acetophenones initiator, diphenylketones initiator, propiophenones initiator, benzophenones initiator, α-hydroxyketones initiator, fluorenylphosphine oxides initiator, and combinations thereof.

15. An image display comprising an anti-glare film as claimed in claim 1.
